(19) United States
(12) Patent Application Publication
(10) Pub. No.: US 2018/0239960 A1
(43) Pub. Date: Aug. 23, 2018

(54) Method and Apparatus for Creating a Supplier Data Set Containing Information about a Service Supplier

(71) Applicants: Christina Wunderlich, Essen (DE); Susanne Bach, Utrecht (NL); Thomas de Bresser, Kerkdriel (NL); Alexander Harding, London (GB); Adam Howard, London (GB); Peter Parkes, London (GB); Owen Thomas, London (GB); Marcin Kolago, Essen (DE)

(72) Inventors: Christina Wunderlich, Essen (DE); Susanne Bach, Utrecht (NL); Thomas de Bresser, Kerkdriel (NL); Alexander Harding, London (GB); Adam Howard, London (GB); Peter Parkes, London (GB); Owen Thomas, London (GB); Marcin Kolago, Essen (DE)

(73) Assignee: innogy Innovation GmbH, Essen (DE)

(21) Appl. No.: 15/955,913

(22) Filed: Apr. 18, 2018

Related U.S. Application Data
(63) Continuation of application No. PCT/EP2015/074259, filed on Oct. 20, 2015.

(51) Int. Cl. G06K 9/00; G06Q 30/04; G06F 17/30

(52) U.S. Cl. CPC G06K 9/00463; G06K 2209/01; G06F 17/30985; G06Q 30/04

(57) ABSTRACT

The subject matter relates to a method for creating a supplier data set containing information about a service supplier. A new tariff can be offered to the user by receiving an electronic copy of a bill from a client via a wide area network, extracting from the copy of the bill at least data characterizing the bill, comparing at least part of the extracted data characterizing the bill with bill templates stored within a database to determine a current type of tariff, analyzing the current type of tariff, and preparing the supplier data set based on the result of the analyzation.

### CROSS-REFERENCE TO RELATED PATENT APPLICATION

This patent application is a continuation of PCT/EP2015/074259, filed Oct. 20, 2015, the entire teachings and disclosure of which are incorporated herein by reference thereto.

### FIELD OF THE INVENTION

The subject matter relates to a method for creating a supplier data set containing information about a service supplier. The subject matter further relates to a method for receiving a supplier data set as well as an application program for receiving a supplier data set.

### BACKGROUND OF THE INVENTION

A service provider according to the subject matter may, for instance, be a utility provider, for instance providing electricity to a user. Moreover, a service provider (also called service supplier) according to the subject matter can also be a provider of gas, an operator of a mobile communication network or any other supplier providing services or consumption material to a user on a regular basis. The above mentioned service suppliers are in particular relevant, since they provide to the user, on a regular basis, bills for billing the service provided. The provided bills are based on a contract the user has made with the service supplier. Basis of such a contract is a tariff, which defines the service to be provided as well as the money to be paid for this service. Within a tariff, for instance, certain basic fees as well as consumption based fees can be agreed on.

According to the subject matter, a service provider may also be a provider of an insurance or the like. As such, a customer also has a contract with an insurance in a certain tariff. Again, tariffs can differ.

For instance, utility providers offer various tariffs to users. Users may choose between tariff thus having different basic fees as well as different consumption fees. It has been observed, that tariffs change over time to account for different user demands. Changing tariffs may enable users to select the most appropriate tariff for the prospective use scenario. However, since a contract may have a certain fixed term, users may only be allowed to switch tariffs at the end of a term of a contract. In view of the vast amount of different tariffs, it is burdensome for users to select the appropriate tariff. Tariffs may not only differentiate between one another based on the amount of consumption, but also may vary based on, for instance, the location of the user's premises. Since a huge amount of different tariffs are available and the tariffs differentiate based on various parameters, the selection process is difficult for the customer, as he has to look for data, which is not reliably available for selecting the most appropriate tariff. On the other hand, if the tariff is selected on only a small set of data, the selected tariff might be incorrect in regard to possible savings.

For these reasons, there is a need for an easy supplier selection process, which is supported by an automatic process according to that subject matter. Also an insurance contract may have an end of term and the selection of a new insurance may also be required.

### BRIEF SUMMARY OF THE INVENTION

This object is solved, according to the subject matter by embodiments of a method as disclosed herein.

By way of the disclosed method, the user can be provided with a supplier data set, within which, during an automatic selection process, the most appropriate service provider with the most appropriate tariff is presented to the user. Within the data set there can be provided information about the service provider as well as a tariff. Moreover, within the supplier data set, there can be provided a term of a contract, a price per units as well as a fixed price or signing bonus. Also, information about an insurance may be provided within the supplier data set. Within the data set there may also be provided information about a product and the supplier of the product as well as the price of the product. Moreover, in such a dataset there may be provided information about at least two different suppliers of the product together with the respective prices for the product. The product may be any good available for sale.

For instance, electricity is provided to a user based on a basic fee and a consumption based fee. The basic fee oftentimes varies and is lower with higher prospective consumption and vice versa. Possibly, a basic fee may, for instance, be meant to cover the cost for providing the meter and the basic infrastructure. The consumption based price may be meant to cover the cost per, for instance, each unit of consumption, e.g. each kWh consumed.

The same scheme may also be applied for a gas supplier. There may, for instance, also apply a basic fee, which might be charged for providing the meter and the infrastructure. In addition or alternative thereto a consumption based fee may be calculated based on the units (in m³) of gas consumed used by the user during a certain period, for instance during a year.

Another example may for instance be a phone tariff, where the user might pay a basic fee for the infrastructure and/or a consumption based fee based for instance on the time used for telephone service of the amount of data transferred.

In addition, there are tariffs comprising a so called flat-fee, which covers all the users cost. Such a flat fee may also be subject to a tariff.

These and other service suppliers with their respective tariffs may be understood as falling within the subject matter. Also a product together with it's respective price may be understood as falling within the described.

In addition, and possible distinct from the above and as such an invention, a price of a product may also be compared using the described methods and apparatus'. In this regard, not a copy of a bill is created, but instead a copy of a product label, which will be handles similar to a copy of a bill. The below thus will apply also for copy of product labels, when replacing the word “bill” with the word “product label”. A user my want to receive information about different prices of this product, which he can obtain using the methods and apparatus described below. It may be possible, that once a product has been found, or at least a product type—similar to a current tariff—has been identified, a data set comprising information about similar product types may be generated to be presented to the user.

Within a central server, there is received an electronic copy of a bill from a client via a wide area network (WAN). An electronic copy of a bill may, for example be an image, a picture, a facsimile or any other electronic representation of the bill. The bill may, for instance, be a printout. On the other hand, it may also be possible that the bill itself may already be provided as an electronic document, for example as a pdf-document, such that the electronic copy may also be a copy of such a document.

In order to generate the electronic copy of the bill, the client, which may be a smart phone, tablet, personal digital assistant, mobile phone, laptop computer or any other type of electronic device may be used to take a photo of the bill.

Within the client, there may be provided an image capturing means, for instance a camera or the like, with which it is possible to create the electronic copy of the bill.

The electronic copy is sent from the client to the server via the wide area network. A wide area network may, for instance, be a cellular communication network, a packet based communication network, a connection based electronic network, the internet, a wireless local network, a near field communication network, a powerline network or any combination thereof.

Within the client or within the central server, from the electronic copy of the bill at least data characterizing the bill may be extracted. Data characterizing the bill may, for instance, be the format of the bill, the size of the bill, the arrangement of objects on the bill, the size and type of objects and pictures on the bill, symbols or the like on the bill, tariff information on the bill or any other information, which may be used to characterized the bill, in particular to characterize the tariff on which the bill is based.

After the data characterizing the bill has been extracted, this data may be used to find out which is the current tariff the bill is based on. For this reason, at least part of the extracted data characterizing the bill is compared with bill templates stored within a database to determine a current type of tariff. In order to determine, what the current tariff is, there may be provided a database, within which templates of bills are stored. These templates represent the characteristics of bills belonging to certain tariffs. For instance, logos, images, positioning of elements, combinations of symbols and numbers (e.g. the tariff name) and the like may be characteristic for a certain tariff. If such characteristics have been found, they may be stored in the template and used to determine, which tariff the current bill belongs to.

It may also be possible to extract data characterizing the product and compare these data with product templates, for instance to find out the product category, or the product itself.

Once the current tariff has been found by using the database with the bill templates, the current type of tariff can be analyzed and based on this analyzation the supplier data set can be compiled. The step of analyzing the current tariff may, for instance comprise the step of checking, whether there are different tariffs, which suit better for the customer based on information about the customer's consumption and/or the characteristics of the current tariff and/or on the customer's location and/or past customer behavior. As will be described later, this additional data may also be obtained from the bill or may be requested from the user.

Since within the server there may be information available about many tariffs, the most appropriate tariff may be selected and the respective supplier data set may be created to be sent to the user via the wide area network.

Once the supplier data set is created, the user is presented—preferably on a display of the client device or per email—information about the tariff as well as the supplier and contract data and may select the appropriate contract with the corresponding tariff to be used for future use of the service of the service supplier.

In order to improve the analyzing step of analyzing the current type of bill, it may be helpful to further extract from the copy of the bill at least data charactering the user. It is common, that on the bill at least the user name and the user address is provided. In addition, a user (customer) ID may also be provided. All this information may be considered data characterizing the user. In particular the user's address may be relevant for analyzing the current tariff and selecting a more appropriate tariff, since there are certain tariffs available possibly only in certain locations or the fees of the tariffs differ based on the location. In particular the zip code may be relevant for the tariff, so that this information may at least be extracted from the copy of the bill as data characterizing the user.

Since the tariffs may differentiate based on the amount of consumption of the service, for instance based on the amount of units (e.g. kWh, Minutes, Kilobytes, m³) used by a user in a certain period (e.g. a month, a year), such information may also be relevant. Thus, the extracting step may also comprise extracting from the copy of the bill at least data characterizing usage. The data characterizing the usage can be the above mentioned data, from which it can be determined, how long or which amount of service a user has requested from the service supplier in a previous period. This information may be extrapolated into the future, so that future use of service can be estimated and based on this estimation, a new tariff can be selected, which suits more appropriate to the user's needs.

As has been mentioned above, the copy of the bill may be captured using a client device. During this capturing, the alignment of the bill may be inappropriate, for instance, the picture of the bill can be a taken in an angle.

In order to enable comparing the bill with the templates, it is appropriate if the copy of the bill is normalized. Normalizing may result in, for instance, aligning the bill along a defined axis. For instance, the outer edges of the bill may be aligned along a vertical or a horizontal axis, i.e. in order to bring the bill into a portrait or a landscape mode. For this, it may be appropriate to carry out edge detection on the copy of the bill. By using the edge detection, for instance the outer edges of a bill or the lines of a text of the bill may be detected and be brought into alignment with the vertical and/or horizontal axis on a picture plane. Thus, the edges of the bill can be aligned in order to enable comparison of the copy of the bill with bill templates.

Moreover, in order to extract the data characterizing the bill, data characterizing the user and/or data characterizing the usage, optical character recognition (OCR) may be carried out. This may, for instance be carried out on the server side or on the client side.

According to an embodiment, comparing the data characterizing the bill with bill templates may comprise finding similar objects within the copy of the bill and the bill templates. Objects may, for instance, be logos, pictures, images, lines, textual elements or the like. Within a bill template, objects characterizing a certain tariff are stored. In order to determine, which tariff a current bill belongs to, the objects within the copy of the current bill can be compared with objects in bill templates and thus the most matching bill template can be found. Once a matching bill template has be found, i.e. the bill template within which a certain amount of objects are similar, the current bill can be mapped onto a certain type of a tariff, i.e. the tariff the corresponding bill template stems from.

Moreover, within a bill template, according to an embodiment, objects can be arranged in certain spatial positions. The spatial position of the objects may also be characterizing for a certain tariff. Thus, the copy of the current bill, more precisely the objects within the copy of the current bill are analyzed regarding their spatial position. It is searched for similar objects in similar spatial positions within the bill templates. The most matching bill template may be used for mapping the current bill onto.

Also, according to an embodiment, the format of a bill template can be used for determining the tariff of the current bill. Formatting may, for instance, be understood as the overall arrangement of the textual elements within the bill. This may, for instance, comprise a head a line with the users address, a subject line, for instance in bold with a name of a tariff and the arrangement of usage data in a certain positioning. Again, the format of the copy of the current bill can be compared with formats of bill templates and the bill template, which is best matching can be found.

Based on which bill templates are found to be best matching, the current tariff can be determined.

Once a current tariff has been found, it is possible to determine whether the user can use a different tariff resulting in a lower price to pay for the service used. Thus, based on the data characterizing usage and/or based on the data characterizing the user and/or based on the data characterizing the tariff including but not limited to opinions of other users, different tariffs stored in a database can be compared with the current tariff. It may be possible, to calculate which bill amount different tariffs would result in based on the data characterizing the user and/or the data characterizing usage. This can be compared with the bill amount of the current tariff. In addition, it may be possible to alter data characterizing usage, in particular the amount units used in a certain bandwidth, for instance by +/−10%. Within this bandwidth, the amount of the bill could be checked for different tariffs stored in the database and the current tariff. Based on the results, it may be determined, which tariff results for the user in the lowest average bill amount. Such a tariff can be offered to the user, as will be described hereinafter.

It has been described above, according to an embodiment, comparing the current type of the tariff with the stored tariffs may comprise finding a new tariff which results, based at least on the data characterizing usage, in a lower amount of the bill than the amount of the current bill. Thus, it is possible to offer the user a new tariff, which will result in a lower amount of the bill automatically.

It has been found, however, that certain tariffs are bound to certain terms of contract. Changing a tariff is only possible within the notice period at the end of the term of a contract. The duration of the term is depending on the tariff. Once the tariff is known, the term of contract can be calculated. In particular the start of a term may be obtained from the copy of the current bill and based on the duration of term, the end of term can be calculated. Thus, according to an embodiment, from the current type of tariff and preferably the data characterizing the user, which data may also comprises the start of term, at least the end of term of contract is determined. Also, the term of the contract may be explicitly presented on the bill and thus, according to an embodiment, may be determined directly from the copy of the bill.

Since a change of tariff is only possible at the end of the term, once the end of the term has been determined, the user can be offered a new tariff at the end of such a term.

It may happen that the data present on a bill is not sufficient to determine a current type of a bill and/or to determine a new tariff. Therefore, it may be necessary to prompt the user to manually enter required data, which could not be determined automatically. Also, during recognizing data on the copy of the bill, character recognition can be corrupted and thus certain data may not be determined. Also such kind of data may be requested from the user. Thus, after data characterizing the tariff and data characterizing the user and/or data characterizing usage (consumption) have been extracted, it may happen that it is found that this data is not sufficient or incomplete. If this is the case, a request may be generated, according to an embodiment, for prompting the user to input further data. Such a request may specify, which type of data the user needs to input, for instance data characterizing the tariff and/or the data characterizing the user and/or data characterizing consumption.

This request may be sent from the server to the client via a wide area network. On the client device, the request may be transferred into a display on the user's device display. The user may be queried about the missing data. However, all or some other data, which may have been extracted from the copy of the bill already can be presented to the user on the display and/or the user needs not to enter. It may happen that in the request for prompting the user to input further data, the already extracted data may be included and presented to the user. The user may then check, whether the extracted data is correct. It may also be possible that without such a request for prompting the user, the user is presented the data, which has been extracted from the bill such that the user may check that this data is correct.

Based on the data extracted from the bill as well as on the data input by the user, if necessary, which is sent via the wide area network from the client device to the server, a new tariff can be found as has been described above. Once the new tariff has been found, according to an embodiment, the supplier data set is generated comprising at least information about the new tariff. Within this data set, information about the new tariff, information about the service provider of the tariff, information of the term, information of the price per unit and/or information of a fixed price may be included, inter alia. The data set is prepared to be sent via the wide area network from the server to the client.

Within the client device, when the supplier data set is received, according to an embodiment, the user is presented information about the new tariff. This information may be extracted from the supplier data set. It may be necessary to request further information from the user and thus it may be necessary to prompt the user to input further data, however, this prompt may only be presented if necessary. Still, since the new tariff is offered to the user, the user may choose to accept this offer. Thus, information about the user's acceptance of the new tariff may be requested, for instance, by requesting the user to press a confirmation button. The user's acceptance may, according to an embodiment, be enriched with the user input. Either the information about the user acceptance or the input user data or both may be sent via the wide area network from the client to the server.

The transfer of information between the client and the server may be an over the top service, such that unspecified data packets are exchanged, which are interpreted in the client by an appropriate application and in the server by an appropriate application. Also, it may be possible to exchange data, for instance, using short message services, email services, or any other kind of text services having an already standardized format.

The user may choose to select a new tariff by simply clicking an approval button within his client device provided by the appropriate application.

Within the server, in response to sending the supplier data set, a response is expected from the client. According to an embodiment a response is received containing at least information about the user's acceptance of the new tariff.

It has been found, that users are more inclined to change to a new tariff near the end of the term of the current tariff. Thus, once an appropriate tariff has been found, the offer, i.e. the supplier data set, may be sent to the user only close to the end of the term.

The selection process of the new tariff may also depend on details of the current tariff, i.e. whether in the copy of the bill or the current tariff it has been found that the user has selected certain characteristics for its tariff. This may, for instance, be a tariff with certain characteristics of the service. For an electricity tariff, this characteristic may for instance be that the electricity stems from renewable sources, i.e. biogas, wind, solar power. If such a user preference has been found, the new tariff may be selected based on such user preferences.

Also, some users are inclined to cash back bonuses. If the user had selected such a cash back bonus tariff, the new tariff may also comprise such a cash back bonus.

Also, based on the data characterizing the user, it may be determined, which tariffs similar users or the user have previously selected. Also this information may be used to determine a new tariff. The user may be presented information, which tariffs similar users have selected.

The user may also indicate that he is inclined to only select such suppliers, which have high user ratings. Also, in the selection process, this information may be used for finding a new tariff. In particular the information about a certain rating, the information about tariff characteristics such as renewable and/or cash back, may be requested from the user in a user prompt to enrich the data being extracted from the bill.

Once the user has given his consent to the new tariff, a notice of termination may automatically be generated. If a user's signature is necessary, this signature may be asked for by sending the notice of termination via usual mail to the user automatically. The notice of termination is, according to an embodiment, preferably generated prior to the end of the term of the contract. After all formalities for the notice of termination have been met, this message is preferably sent to the service provider of the current tariff. In many cases, only textual information may be sufficient, such that such a message may also be send via email to the service provider of the current tariff.

There may be certain services, which are used in a varying intensity over time. For instance, a phone tariff may be subject to varying usage. Using only one copy of a bill to determine a new tariff may be misleading. Thus, it may be possible to use more than one copy of one bill to determine a new tariff. According to an embodiment, at least copies of two different bills are received from one user. The user may take, over a period of time, copies of several bills and sent them to the server, one after the other. From each of the bills, data characterizing the usage may be extracted besides extracting the data characterizing the user and the data characterizing the tariff. If the user has already sent one bill previously, determining the tariff may be obsolete, if the copy of the new bill matches in format and other information with a previously sent copy of a bill. Since, the bill is received from the same user extracting data characterizing the user may be obsolete. Thus, it may be possible only to extract data characterizing consumption.

With the data characterizing consumption over different periods, it is possible to combine this information. In particular, a median consumption may be determined. According to an embodiment, an average usage is determined such that average usage data is created. Based on the average usage data, the new tariff can be selected.

In order to be able to inform the user about new options, it may be possible that for each new tariff a term of contract is stored. Once the new tariff has been selected and used by the user, it may be possible to inform the user about new options at the end of such a term. Thus, it may be possible that at the end of the term of the contract, the user is automatically prompted to provide a copy of a current bill. This may be done by sending an appropriate message from the server to the client and displaying this message on the user's device. Based on the new copy of the current bill, the new supplier data set, as has been described above, may be created.

Another aspect is a method for receiving a supplier data set containing information about a service supplier. First of all, a copy of a bill may be created, for instance using a camera in the client device. This copy may be sent via a wide area network to a server. After the copy has been sent, a supplier data set may be received from the server. It may be possible that further input is requested and upon such input of data, the supplier data set is received. Then, the user may be prompted to input acceptance for a new tariff, information about which is provided in the supplier data set. The user's acceptance may then be sent to the server via the wide area network.

Another aspect is an application program according to embodiments described herein.

### BRIEF DESCRIPTION OF THE SEVERAL VIEWS OF THE DRAWING

These and other aspects will become more apparent from the following figures. In the figures show:

FIG. 1 shows a representation of a bill according to an embodiment;

FIG. 2 shows a copy of a bill according to an embodiment;

FIG. 3 shows extracting of data from the copy of the bill according to an embodiment;

FIG. 4 shows prompting the user for further input according to an embodiment;

FIG. 5 shows determination of a current tariff according to an embodiment;

FIG. 6 shows selection of a new tariff according to an embodiment; and

FIG. 7 shows requesting a user's acceptance to a new tariff according to an embodiment.

### DETAILED DESCRIPTION OF THE INVENTION

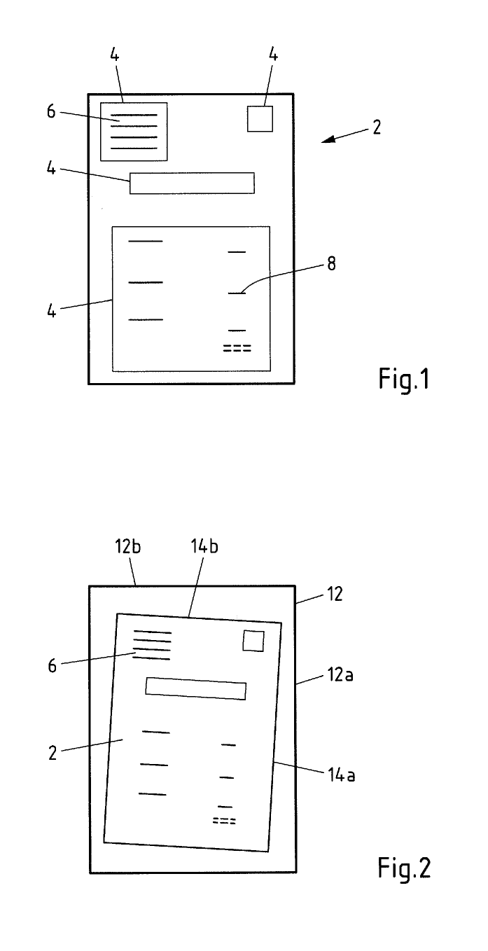

FIG. 1 illustrates an example of a bill 2. The bill 2 may comprise information 4 characterizing the bill, information 6 characterizing the user and information 8 characterizing consumption. In the example, the bill 2 represents an electricity bill of a utility provider.

Within the bill 2, the arrangement of the objects and textual information is marked as information 4. Within the objects of information 4, the actual textural information 6 may characterize the user. Also the actual textural information 8 within the box 4 may represent consumption data. Thus, information 4 characterizing the bill may in addition contain information 6 and information 8, which in particular is textual information.

With a client device 10, for instance a smart phone, the user may take a picture of the bill 2. Such a copy of the bill 2 is illustrated in FIG. 2. Therein, the picture 12 of the bill 2 is shown. As can be seen, within the picture 12 the alignment of the bill 2 is not correct. This may happen, when the user uses a camera and does not exactly align the bill within the frame of the picture 12.

In order to determine the type of the tariff and in order to determine information 4 and information 6, it may be appropriate to align the copy of the bill 2 within the picture 12. This can be done, for instance, by aligning the vertical edge 14a with the vertical edge 12a of the picture 12 and/or the horizontal edge 14b with the horizontal edge 12b of the picture 12. Also, the lines of information 6 may, for instance be brought into a parallel arrangement with the edge 12b.

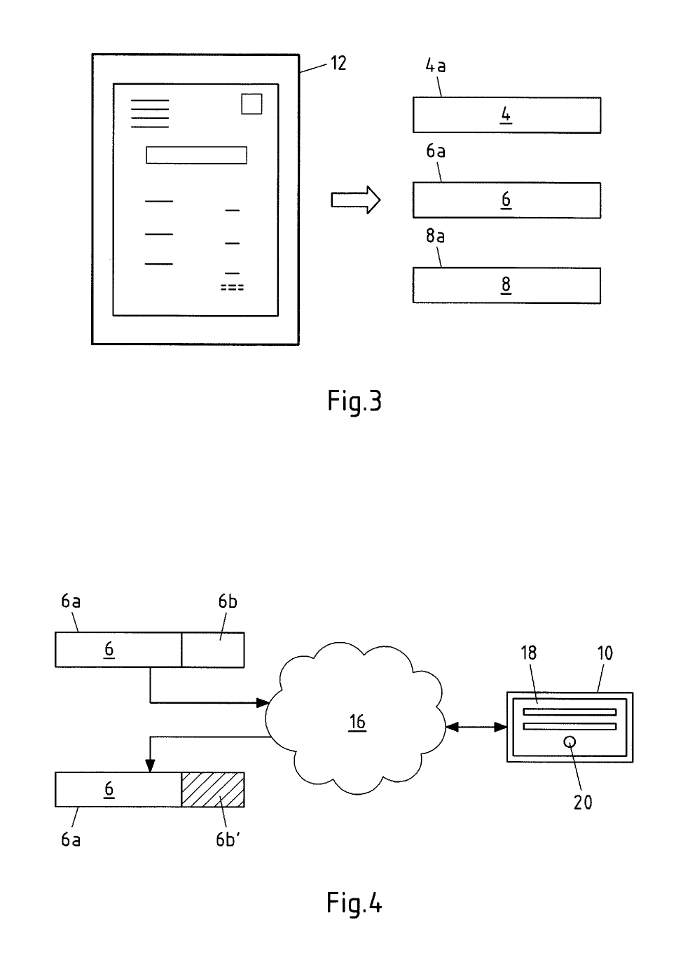

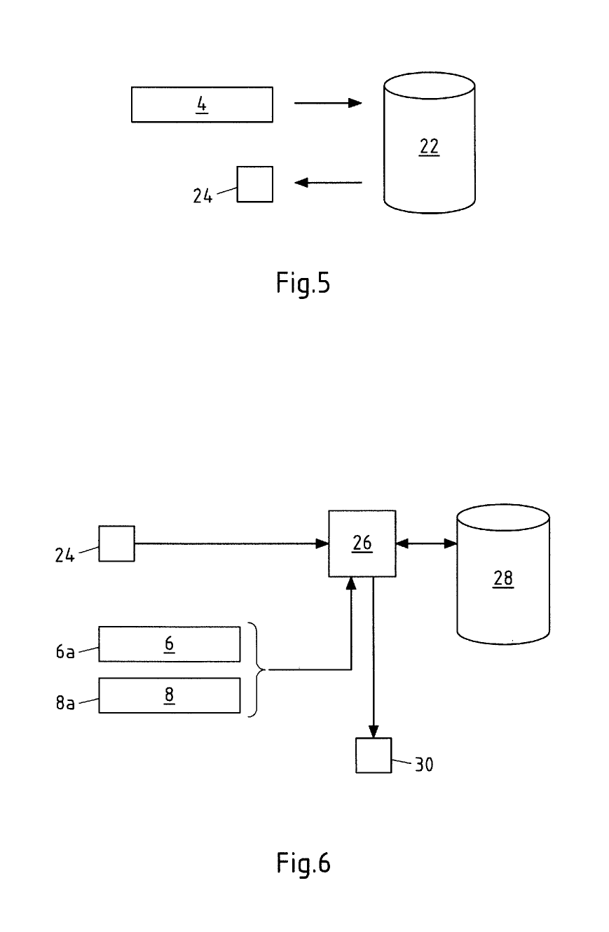

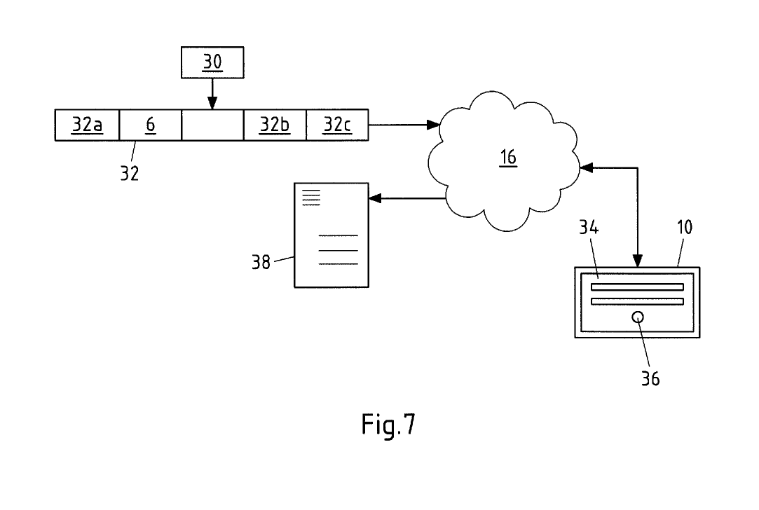

By aligning the picture 12 of the bill 2, the picture 12 is normalized meaning that almost any type of a picture 12 has a certain minimum quality as regards alignment. It may also be possible to normalize the picture 12 by color correction, brightness correction, contrast correction and the like. Once picture 12 is normalized, it can be used as illustrated in FIG. 3.

Within FIG. 3 it is shown that from the picture 12 a data set 4a is extracted, containing the information 4 characterizing the bill. Moreover a data set 6a comprising information 6 characterizing the user is extracted and a data set 8a comprising information 8 characterizing consumption is extracted. These three data sets 4a, 6a, 8a are used to first determine the current tariff and then to determine a new tariff, which suits better to the consumption of the user.

It may happen that for instance the information 6 characterizing the user within a data set 6a may be incomplete. This is illustrated in FIG. 4. It is shown that in data set 6a there is an area 6b of information 6, which is missing. This missing information may be requested from the user in a user prompt. Therefore, a server transmits a corresponding request via a wide area network 16 to the client device 10. On the client device 10, there is running an application program, which is programmed to receive such a request. The program is programmed to display on the screen of client device 10 a user prompt 18 requesting the user to input the missing pieces of information and a send button 20. Upon completion of the information, the user may press the send button 20 and the completed information is transmitted via the wide area network 16 to the server. Within the server, the data set 6a is completed with the additional information 6b′.

Within the user prompt 18, the already extracted information 6 may also be presented to the user and the user may correct this information if incorrectly extracted. Thus, the user has the chance to rectify any mistakes during extraction of information 6.

The same may be carried out for information 4 as well as information 8 but will not be describe in detail. The enrichment of data by user input by requesting parts of information 4, 6, 8 may be done in one step or in single steps.

Once the information 4 characterizing the bill are completely recognized or enriched by users input, the data set 4 is used to determine from a database 20 a current tariff. This is done by comparing the spatial positioning of the information 4 on the bill 2, the color of the information 4, the size of the information 4 and much other information 4 characterizing the bill. All these information are compared with bill templates stored in a data base 22. The best matching template is found and put out by database 22 as information 24 about the current tariff.

It may happen that the templates within the database 2 do not match with the information 4 characterizing the bill from the current bill. This may on the one hand result from a bad picture of the bill 2 or that the current bill 2 has no corresponding template in database 22.

In such a case the server may prompt a human operator to check the copy of the bill. The human operator may decide whether the copy of the bill is only a bad copy and should match with a stored template or whether the current bill relates to a tariff for which no bill template is present in the data base 22. In the latter case, a new bill template may be created and stored in a database 22.

Also, the layout of bills of certain tariffs may change over time. Such a change in a layout may result in that no matching template is found. Also in such a case, the human operator may update the bill templates within database 22 upon request from the server.

Once information 24 about the current bill has been found, this information is combined with information 6 in data set 6a and information 8 in data set 8a. The information 6, 8 together with the information 24 is input into server 26. Server 26 interrogates a further database 28 within which information about different tariffs are stored. Based on the information 6 characterizing the user and information 8 characterizing consumption and the information 24 about the current tariff, different scenarios of bill amounts may be calculated. These scenarios may also be calculated for different tariffs obtained from database 28, and the best matching tariff may be selected. This may, for instance, be the tariff, which results in the lowest bill amount. If such a new tariff is found, information 30 about a new tariff is output from server 26.

Information 30 is input into a service supplier data set 32 together with information 32 about the service provider, information 6 characterizing the user, information 32b indicating a fixed price and information 32c indicating a consumption based price. The data set 32 is sent via wide area network 16 to client device 10. On client device 10 the application program is running and interprets data set 32. It extracts information 32a, 6, 30, 32b, 32c and presents this information in a user prompt 34 to the user.

In the user prompt 34, additional information may be requested from the use. Once the user has input the requested information and checked all other information, he may press an accept button 36. Upon pressing the accept button 36, the application program on the client device retransmits the data set 32, possibly enriched with user input, via wide area network 16 to the server. On the server, a notice of termination 38 is automatically generated and sent via mail, e-mail or any other channel to the current service provider. In addition, a contract (not shown) is made with the service provider of the new tariff.

The user has been able to automatically switch to a new tariff, which better suits a consumption need. The method as shown above can be repeated any time in particular in times when a term ends. The end of the term can be stored in the server and shortly before the end, the user may be prompted to provide a new copy of his bill.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for creating a supplier data set containing information about a service supplier comprising:
receiving an electronic copy of a bill from a client via a wide area network,
extracting from the copy of the bill at least data characterizing the bill,
wherein extracting data from the bill comprises at least normalizing the bill by aligning the copy along a defined axis in particular using at least edge detection on the copy and aligning the edge,
analyzing a spatial position of objects within the normalized bill,
comparing at least part of the extracted data characterizing the bill with bill templates by finding objects being spatially arranged on the bill at similar positions on bill templates stored within a database to determine a current type of tariff,
analyzing the current type of tariff, and
preparing the supplier data set based on the result of the analyzation.

2. The method of claim 1, further comprising:
extracting from the copy of the bill at least data characterizing the user.

3. The method of claim 2, further comprising:
extracting from the copy of the bill at least data characterizing usage.

4. The method of claim 1, wherein extracting data from the bill comprises optical character recognition.

5. The method of claim 1, wherein comparing the data characterizing the bill with bill templates comprises finding similar objects within the copy of the bill and the bill templates, and/or comparing a format of the bill with formats of the bill templates.

6. The method of claim 3, wherein the determined current type of tariff is compared with tariffs stored in a database based at least on the data characterizing the user and the data characterizing usage and/or the data characterizing the current tariff.

7. The method of claim 6, wherein comparing the current type of tariff with the stored tariffs comprises finding a new tariff which results, based on the data characterizing usage, in a lower amount of the bill than the amount of the current bill.

8. The method of claim 1, wherein
from the current type of tariff and preferably the data characterizing the user at least the term of a contract is determined or
from the copy of the bill the term of the contract is determined.

9. The method of claim 6, wherein after data characterizing the tariff and data characterizing the user have been extracted, a request is generated for prompting the user to input further data characterizing the tariff and/or data characterizing the user.

10. The method of claim 7, wherein after the new tariff has been found, the supplier data set is generated comprising at least information about the new tariff.

11. The method of claim 10, wherein when the supplier data set is received, the user is presented information about the new tariff and is prompted to input further user data and that information about a user's acceptance of the new tariff is enriched with the user input and sent via the wide area network.

12. The method of claim 11, wherein in response to sending the supplier data set a response is received containing information about the user's acceptance of the new tariff.

13. The method of claim 12, wherein in response to information about the user's acceptance a message is generated for terminating the current tariff, wherein the message is preferably generated prior to the term of contract, and wherein the message is preferably sent to the service provider of the current tariff.

14. The method of claim 1, wherein at least two copies of two different bills are received from one user, wherein at least data characterizing the usage of the received bills is extracted and the data characterizing the usage of the received bills is combined, in particular an average usage data is created.

15. The method of claim 7, wherein for each new tariff a term of contract is stored and prior to the end of the term of contract the user is prompted to provide a copy of a current bill to create a new supplier data set.

16. A method for receiving a supplier data set containing information about a service supplier comprising:
creating an electronic copy of a bill,
sending the electronic copy of a bill to a server via a wide area network,
receiving the supplier data set,
prompting the user for inputting a user's acceptance of a new tariff provided within the supplier data set,
sending information about the user's acceptance to the server via the wide area network.

17. An application program for receiving a supplier data set containing information about a service supplier comprising:
operating a camera to create an electronic copy of a bill,
operating a communication unit to send the electronic copy of a bill to a server via a wide area network,
receiving the supplier data set via the wide area network using the communication unit,
operating a display to prompt the user for inputting a user's acceptance of a new tariff provided within the supplier data set,
sending information about the user's acceptance to the server via the wide area network using the communication unit.
